(19) United States
(12) Patent Application Publication
(10) Pub. No.: US 2026/0253238 A1
(43) Pub. Date: Aug. 27, 2026

(54) Structured Light Depth Sensors Incorporating Metasurfaces

(71) Applicant: Metalenz, Inc., Boston, MA (US)

(72) Inventor: Mohammad Salary, San Francisco, CA (US)

(73) Assignee: Metalenz, Inc., Boston, MA (US)

(21) Appl. No.: 19/648,860

(22) Filed: Apr. 15, 2026

Related U.S. Application Data
(63) Continuation of application No. 18/596,487, filed on Mar. 5, 2024.
(60) Provisional application No. 63/488,517, filed on Mar. 5, 2023.

(51) Int. Cl. G06T 7/521; G01B 11/22

(52) U.S. Cl. CPC G06T 7/521; G01B 11/22; G06T 2207/10028; G06T 2207/20021

(57) ABSTRACT

Systems and methods for sensing depth may utilize a baseline matrix for correlating different baselines with their corresponding centers of diffraction. In one particular example, a depth sensing system includes: a projector including: a light source and a metasurface, where the light source illuminates the metasurface at different transverse locations such that the metasurface projects light in different transverse locations onto an object; a receiver including an image sensor configured to receive light that is reflected from off the object, where the projector and the receiver are a fixed distance apart such that the light in different transverse locations has a plurality of centers of diffraction which correspond to different baselines which are the distance between the centers of diffraction and a fixed point of the receiver, and where the light received by the image sensor corresponds to different disparities based upon the depth of the object.

### CROSS-REFERENCE TO RELATED APPLICATIONS

This current application is a continuation of U.S. patent application Ser. No. 18/596,487, entitled “Structured Light Depth Sensors Incorporating Metasurfaces”, filed Mar. 5, 2024 and published as US 2024-0296575 A1 on Sep. 5, 2024, which claims the benefit of and priority under 35 U.S.C. § 119(e) to U.S. Provisional Patent Application Ser. No. 63/488,517, entitled “Depth Sensing with Structured Light using an Integrated Meta-Optic” and filed Mar. 5, 2023, the disclosures of which are incorporated herein by reference in their entireties for all purposes.

### FIELD OF THE INVENTION

The present invention generally relates to structured light depth sensors incorporating metasurfaces.

### BACKGROUND

Metasurfaces include a plurality of metasurface elements. Metasurface elements are diffractive optical elements in which individual waveguide elements have subwavelength spacing and have a planar profile. Metasurface elements have recently been developed for application in the UV-IR bands (300-10,000 nm). Compared to traditional refractive optics, metasurface elements may abruptly introduce phase shifts onto light field. This enables metasurface elements to have thicknesses on the order of the wavelength of light at which they are designed to operate, whereas traditional refractive surfaces have thicknesses that are 10-100 times (or more) larger than the wavelength of light at which they are designed to operate. Additionally, metasurface elements may have no variation in thickness in the constituent elements and thus are able to shape light without any curvature, as typically included in refractive optics. Compared to traditional diffractive optical elements (DOEs), for example binary diffractive optics, metasurface elements have the ability to impart a range of phase shifts on an incident light field, at a minimum the metasurface elements can have phase shifts between 0-2π with at least 5 distinct values from that range, whereas binary DOEs are only able to impart two distinct values of phase shift and are often limited to phase shifts of either 0 or 1π. Compared to multi-level DOE's, metasurface elements do not require height variation of its constituent elements along the optical axis, only the in-plane geometries of the metasurface element features vary.

### SUMMARY OF THE DISCLOSURE

In some aspects, the techniques described herein relate to a depth sensing system including: a projector including: a light source; and a metasurface, wherein the light source illuminates the metasurface at different transverse locations such that the metasurface projects light in different directions onto an object; and a receiver including an image sensor configured to receive light that is reflected from off the object, wherein the projector and the receiver are a fixed distance apart such that the light in different locations has a plurality of centers of diffraction on the metasurface which correspond to different baselines which are the distance between the centers of diffraction and a fixed point of the receiver, and wherein the light received by the image sensor corresponds to disparities based upon the depth of the object.

In some aspects, the techniques described herein relate to a depth sensing system, wherein the receiver includes an aperture and the fixed point of the receiver includes a point within the aperture, wherein the light reflected off the object passes through the aperture onto the image sensor.

In some aspects, the techniques described herein relate to a depth sensing system, wherein the aperture includes a pinhole and the fixed point of the receiver includes a center of the pinhole.

In some aspects, the techniques described herein relate to a depth sensing system, wherein the aperture includes a lens and the fixed point of the receiver includes a center of the lens.

In some aspects, the techniques described herein relate to a depth sensing system, wherein a separation between the projector and the receiver is between 10 mm to 20 mm.

In some aspects, the techniques described herein relate to a depth sensing system, wherein the distance between the projector and the object is greater than 30 cm.

In some aspects, the techniques described herein relate to a depth sensing system, wherein the distance between the projector and the object is between 30 cm and 120 cm.

In some aspects, the techniques described herein relate to a depth sensing system, wherein the metasurface is configured to collimate and fan-out the light from the light source.

In some aspects, the techniques described herein relate to a depth sensing system, wherein the metasurface projects light in different transverse locations onto the object.

In some aspects, the techniques described herein relate to a depth sensing system, wherein the projected light from the metasurface includes a dot pattern.

In some aspects, the techniques described herein relate to a depth sensing system, wherein the projected light from the metasurface includes pseudo-random or regular light.

In some aspects, the techniques described herein relate to a method of sensing depth, the method including: providing a depth sensing camera including: a projector including: a light source; and a metasurface, wherein the light source illuminates the metasurface at different transverse locations such that the metasurface projects light in different directions onto an object; and a receiver including an image sensor configured to receive light that is reflected from off the object, wherein the projector and the receiver are a fixed distance apart such that the light in different transverse locations has a plurality of centers of diffraction which correspond to different baselines which are the distance between the centers of diffraction and a fixed point of the receiver, receiving a baseline matrix which correlates the different baselines with their corresponding centers of diffraction for the depth sensing camera; capturing a scene including an object; determining the corresponding spots in a reference map of the scene; calculating disparities between the spots in the reference map of the scene and a reference pattern; and calculating the depth of the object based on the disparities while correcting for the different baselines of light projected from the metasurface using the baseline matrix.

In some aspects, the techniques described herein relate to a method, further including thresholding the captured scene, wherein determining the corresponding spots in the reference map of the scene is based on the thresholded captured scene.

In some aspects, the techniques described herein relate to a method, further including calculating the centroid of the threshold captured scene, wherein determining the corresponding spots in the reference map of the scene is based on the centroid of the thresholded captured scene.

In some aspects, the techniques described herein relate to a method, further including binarizing the captured scene, wherein determining the corresponding spots in the reference map of the scene is based on the binarized captured scene.

In some aspects, the techniques described herein relate to a method, further including calibrating the image sensor to create a camera matrix.

In some aspects, the techniques described herein relate to a method, wherein the camera matrix includes a camera focus.

In some aspects, the techniques described herein relate to a method, further including capturing a reference pattern with a known depth.

In some aspects, the techniques described herein relate to a method, further including constructing a depth retrieval model using the reference pattern with the known depth and the baseline matrix.

In some aspects, the techniques described herein relate to a method, wherein the depth retrieval model is expressed by the equation: where Dr is the depth of the reference pattern at spot matching i-th spot in the reference map, Di is a measured depth at the location of the i-th spot in the reference map, bi is the baseline at the location of the i-th spot in the reference map, di is the disparity at the location of the i-th spot in the reference map, and f is a focal distance of the receiver.

In some aspects, the techniques described herein relate to a method, wherein bi is provided by: bi=b+xi, where b is a separation between a center of a pupil of the receiver and a center of the projector and xi is a position of a emitter corresponding to the i-th spot in the reference map.

In some aspects, the techniques described herein relate to a method, further including constructing a general camera model which relates the disparities to the depth of the object using the reference pattern with a known depth and the baseline matrix.

In some aspects, the techniques described herein relate to a method, wherein the general camera model is represented by the equation: where kC is the camera matrix, Dr is the depth of the reference pattern at spot matching i-th spot in the reference map, Di is a measured depth at the location of the i-th spot in the reference map, bi is the baseline at the location of the i-th spot in the reference map, and di is the disparity at the location of the i-th spot in the reference map.

In some aspects, the techniques described herein relate to a method, wherein the reference pattern is a reference plane.

In some aspects, the techniques described herein relate to a method, wherein the metasurface projects a dot pattern onto the object.

In some aspects, the techniques described herein relate to a method, wherein the light source is a VCSEL array.

In some aspects, the techniques described herein relate to a method, wherein the receiver includes an aperture and the fixed point of the receiver includes a point within the aperture, wherein the light reflected off the object passes through the aperture onto the image sensor.

In some aspects, the techniques described herein relate to a method, wherein the aperture includes a pinhole and the fixed point of the receiver includes a center of the pinhole.

In some aspects, the techniques described herein relate to a method, wherein the aperture includes a lens and the fixed point of the receiver includes a center of the lens.

In some aspects, the techniques described herein relate to a method, wherein the metasurface projects light in different transverse locations onto the object.

In some aspects, the techniques described herein relate to a method, wherein the projected light from the metasurface includes a dot pattern.

In some aspects, the techniques described herein relate to a method, wherein the projected light from the metasurface includes pseudo-random or regular light.

### BRIEF DESCRIPTION OF THE DRAWINGS

The description will be more fully understood with reference to the following figures, which are presented as exemplary embodiments of the invention and should not be construed as a complete recitation of the scope of the invention, wherein:

FIG. 1 is an example triangulation-based calculation of disparity in a depth sensing system based on structured light.

FIG. 2 is an example disparity map of dots in a 7×11 dot pattern for a human face model at 40 cm captured by a pinhole Rx with a baseline of 10 mm along horizontal direction.

FIG. 3A is a schematic of a structured light depth sensing system including a projector including a metasurface Tx in accordance with an embodiment of the invention.

FIG. 3B is a schematic of a projection of spots by a conversional projection system.

FIG. 4 is an example projector including a metasurface in accordance with an embodiment of the invention.

The top images of FIG. 5 are examples of a pattern of a 7×11 spot projector.

FIG. 6 illustrates the baseline corresponding to the different spots which may be used for depth retrieval using the projector including the metasurface as illustrated in FIG. 3A.

FIG. 7 is various retrieved depth of flat screens at different distances using a calibration map corresponding to a flat screen at 35 cm and using a constant baseline of 10 mm along horizontal direction.

FIG. 8 is various retrieved depth of flat screens at different distances using a calibration map corresponding to a flat screen at 35 cm and using the baseline matrix shown in FIG. 6.

FIG. 9 is a flowchart of depth retrieval with the projector including a metasurface described in connection with FIG. 3A using a model based on a baseline matrix in accordance with an embodiment of the invention.

FIG. 10 are various disparity maps and their corresponding retrieved depth maps using a baseline matrix for a human head model placed at a distance of 40 cm and different separations between Rx and Tx along the horizontal direction.

FIG. 11 is various disparity maps and retrieved depths for a human head model placed at different distances for a 10 mm separation between center of Rx pupil and center of Tx.

FIG. 12 is a flow chart of a method of sensing depth in accordance with an embodiment of the invention.

### DETAILED DESCRIPTION

Disclosed herein is a method and apparatus for accurate depth retrieval using an integrated metasurface structured light illuminator. The metasurface projects an encoded pattern (such as pseudo-random dot pattern) using projection and replication of a vertical-cavity surface-emitting laser (VCSEL) array or a light emitting diode (LED) or array of LEDs. In some embodiments, the encoded pattern may be a regular dot pattern or other patterns. The metasurface may include integrated collimation and fan-out functionalities into a single surface. It has been discovered that due to emanation of chief rays of different spots in the pattern from different points across the surface of metasurface, applying a depth retrieval method with a constant baseline may lead to inaccurate results at distances far from the distance of reference map. In some embodiments, the method and apparatus described herein uses a baseline matrix by adjusting to the baseline of each spot into the scene according to its corresponding emitter position in the in the metasurface and/or VCSEL layout in order to achieve accurate depth estimation. It is also applicable to a hybrid illuminator (Tx) system based on collimating lens and diffractive optical element in which the diffractive optical element is not placed at the pupil of collimator lens to reduce the total track length (TTL).

Structured light may provide disparity (e.g., displacement of a projected point by changing the viewpoint) similar to stereoscopic imaging with the difference that, in a stereoscopic system, the disparity is calculated from two images captured by two cameras while in a structured light system one of the cameras may be replaced by an illuminator which projects an encoded pattern whose measured displacement can be used for depth retrieval. In recent years, structured light has become increasingly popular owing to its speed and high accuracy of depth estimation while offering higher resolution compared to time of flight (TOF) systems as structured light may not include signal processing at the sensor level. The main disadvantages are vulnerability to ambient light and occlusion.

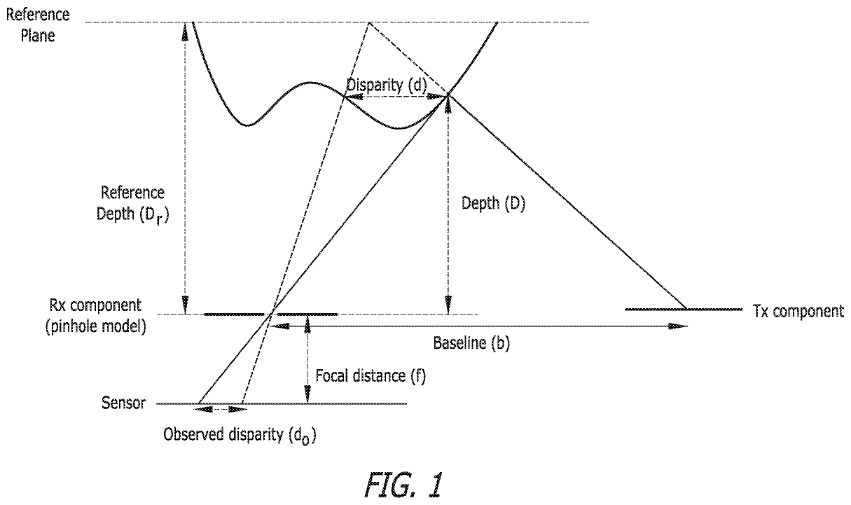

Similar to a stereoscopic system, the disparity and its relation to depth can be calculated based on triangulation. FIG. 1 is an example triangulation-based calculation of disparity in a depth sensing system based on structured light. The depth sensing system includes a transmitter (Tx) component, a receiver (Rx) component, a reference plane with a reference map and an object to be imaged. As illustrated, the Rx may include a pinhole, which is one embodiment and simplifies the system and calculations, especially for ease of description. In some embodiments, apertures, refractive lenses or even multiple pinholes or apertures may be incorporated into the system. In this example, the Tx component is the illumination side of the system and the Rx component is the sensor side of the system.

The distance between the center of the pupil of the Rx component and the Tx component used for illumination may be referred to as baseline (b) which may be the most critical parameter in such a system. For b=0, the displacement of projected spot at different depths may be zero and the wider the baseline, the wider is the displacement of projection for a given deviation of depth from reference. Using similarity of triangles in FIG. 1 yields the following equations:

$$\frac{{D}_{r} - D}{{D}_{r}} = \frac{d}{b} \qquad ( 1 )$$

$$\frac{D}{f} = \frac{d}{{d}_{o}} \qquad ( 2 )$$

Then, the unknown depth of the object at the spot location can be expressed in terms of known depth of reference plane, the pixel displacement of the spot captured by camera relative to captured spot location at the reference plane (observed disparity: dₒ), and camera parameters including focal length (f) and baseline (b):

$$D = {D}_{r} - \frac{{D}_{r}}{1 + ( f \cdot b ) / ( {D}_{r} \cdot {d}_{o} )} \qquad ( 3 )$$

Dᵣ is the depth of reference plane, D is the measured depth, b is baseline, f is focal distance in the pinhole camera model, dₒ is observed disparity in image space, f is the focal distance of pinhole camera model. This equation can be used for depth retrieval using known parameters of the system and a pre-stored image for an object with a known depth for calculation of disparity and accordingly depth. Although, this relation is obtained for a basic pinhole camera model, a similar procedure can be adopted for a general camera model while taking into account distortion effects and blurring of defocused objects. For a general camera, the relation between disparity and pixel offset in image space may be governed by the camera matrix (C) which may be obtained via camera calibration. Equation (2) then changes to the following for a horizontal baseline:

$$[ \begin{matrix}{d}_{o , x} \\ {d}_{o , y} \\ 1\end{matrix} ] = kC [ \begin{matrix}d \\ 0 \\ D\end{matrix} ] \qquad ( 4 )$$

kC is the camera matrix of a general camera obtained through calibration. Using Equation (1) yields:

$$[ \begin{matrix}{d}_{o , x} \\ {d}_{o , y} \\ 1\end{matrix} ] = kC [ \begin{matrix}b \frac{{D}_{r} - D}{{D}_{r}} \\ 0 \\ D\end{matrix} ] \qquad ( 5 )$$

which can be solved for D to retrieve the depth.

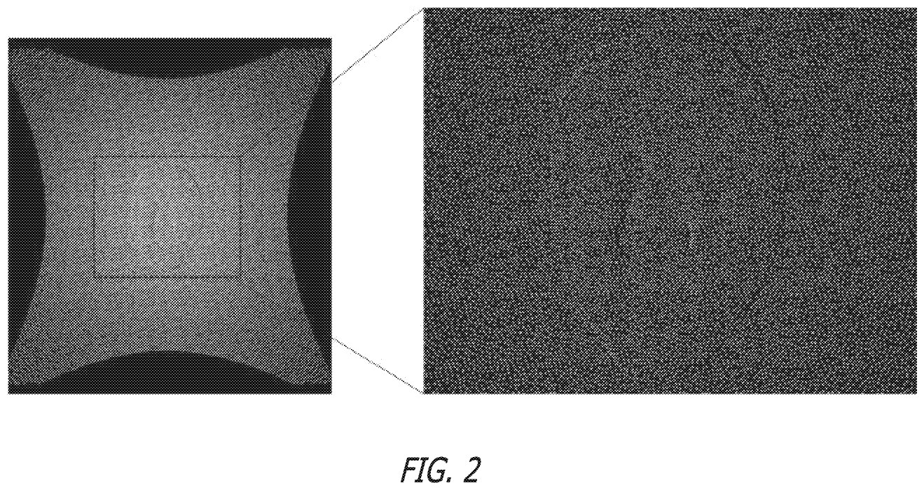

FIG. 2 is an example disparity map of dots in a 7×11 dot pattern for a human face model at 40 cm captured by a pinhole Rx with a baseline of 10 mm along horizontal direction. The displacement of dots in a 7×11 dot pattern for the example human face model at 40 cm may be captured in front of a flat screen captured by Rx with a baseline of 10 mm along horizontal direction. The Rx may be modeled with pinhole camera model. The distortion effects and blurring of spots may not be captured using the pinhole camera model. As it can be seen the pattern may only horizontally displaced due to horizontal baseline. Setting the baseline to 0 mm, no displacement may be observed, so typically 5 mm or more is used as the baseline.

The error in depth estimation and resolution may be analyzed. Assuming a measured error of δd in the disparity measured by Rx, the error in the depth estimation for the basic model can be obtained as:

$$δ D = \frac{{D}_{r}}{1 + ( f \cdot b ) / ( {D}_{r} \cdot ( {d}_{o} ) )} - \frac{{D}_{r}}{1 + ( f \cdot b ) / ( {D}_{r} \cdot ( {d}_{o} + δ d ) )} \qquad ( 6 )$$

Using Taylor series expansion, we will get:

$$δ D = \frac{{D}_{r}^{2} f \cdot b}{{( f \cdot b + {D}_{r} {d}_{o} )}^{2}} δ d \qquad ( 7 )$$

Using Eq. (1), we can simply it further as:

$$δ D = \frac{1}{f {b ( 1 / {D}_{r} + 1 / D )}^{2}} δ d \qquad ( 8 )$$

The error of δd in the disparity measured by Rx may be limited by resolution of camera system. So for a given disparity resolution of δd, the depth resolution does one or more of the following: increases by increasing focal length of Rx system; increases by increasing the baseline; reduces at further distances of observation and calibration.

It has been discovered that a projector including VCSEL arrays with one or more metasurfaces may combine the functionalities of collimation (projection) and fan-out in a single flat surface which are otherwise typically done by a lens stack and a diffractive optical element (DOE). The conventional lens stack would include multiple refractive features which adds complexity to the system. The projector including VCSEL arrays and one or more metasurfaces may be utilized to achieve the most compact form-factor and realize a monotonically integrated illuminator.

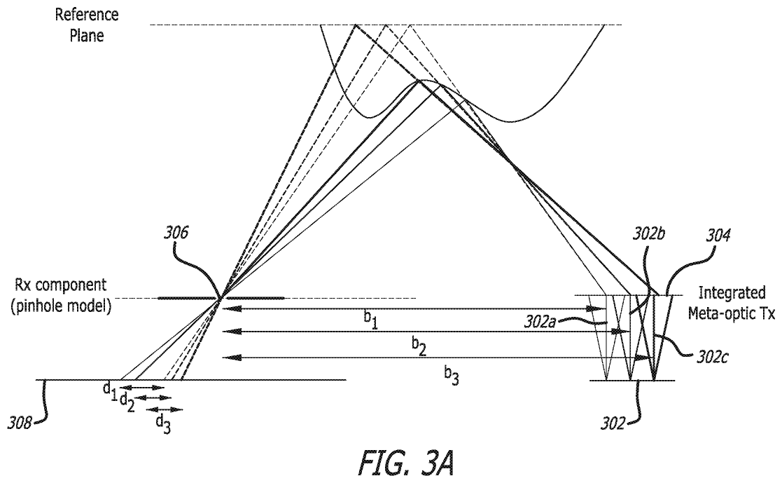

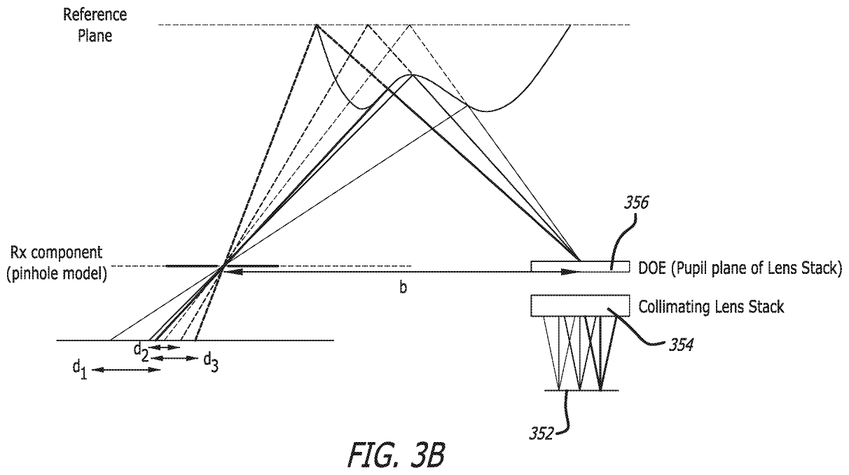

FIG. 3A is a schematic of a structured light depth sensing system including a projector including a metasurface Tx in accordance with an embodiment of the invention. The structured light depth sensing system includes a projector system including a VCSEL light source 302. The VCSEL light source 302 may illuminate a metasurface 304. For illustrative purposes, only one of the diffraction orders is shown in the ray trace. Due to integration of collimation and fan-out in a single surface, the chief rays of VCSEL light source 302 illuminate the metasurface 304 at different transverse locations. Thus, the center of diffraction is not a single point and each spot has a different emanating point. The VCSEL light source 302 may include three different VCSEL light sources which output light at different positions. The different centers of diffraction may include a first center of diffraction 302a, a second center of diffraction 302b, and a third center of diffraction 302c which may correspond to different colored VCSELs of the VCSEL light source 302. The structured light depth sensing system further includes a receiver which includes a pinhole 306 in some embodiments. The center of the pinhole 306 may be separated from the first center of diffraction 302a by a first baseline b₁, the second center of diffraction by a second baseline b₂, and the third center of diffraction by a third baseline b₃.

In other examples, the Rx may utilize other models such as distortion models which may not include a pinhole. The baselines may be the distance between a fixed position of the receiver and the center of diffractions. The first baseline may be the distance between the fixed position of the receiver and the first center of diffraction 302a, the second baseline may be the distance between the fixed position of the receiver and the second center of diffraction 302b, the third baseline may be the distance between the fixed position of the receiver and the third center of diffraction 302c. In the case of the camera system including a pinhole, the fixed position of the receiver may be the center of the pinhole. However, other camera system may include other apertures and aperture sizes such as a lens aperture. In the instance of a lens, fixed position of the receiver may be the center of the lens or a point on the lens or one or more edges of an aperture, and in some embodiments two or more pinholes or apertures could be used.

An image sensor 308 captures light reflected from an object which provides a disparity which is a pixel displacement of a spot captured by the image sensor 308 relative to captured spot location at the reference plane. The light reflected from the object may provide a first disparity d₁, a second disparity d₂, and a third disparity d₃. The different disparities d₁, d₂, d₃ and camera parameters including focal length (f) and different baselines b₁, b₂, b₃ may be utilized to calculate depth.

Each of the baselines may be between the range of 10 mm to 30 mm, 5 mm to 50 mm, 5 mm to 20 mm, or 10 mm to 25 mm.

FIG. 3B is a schematic of a projection of spots by a conversional projection system. The conversional projection system may include a VCSEL light source 352. The VCSEL light source 352 may illuminate a collimating lens stack 354 which may pass light onto a DOE 356. The DOE 356 can be placed at the pupil plane of collimating lens stack in which all the projected chief rays of the VCSEL light source 352 pass through the center; yielding a single origin for all the rays projecting the spots. Utilizing a single origin may increase total track length (TTL) which may decrease resolution of the projection system. Also, the separate DOE and collimating lens stack 354 may increase the thickness module.

In comparison, the projector of FIG. 3A including a metasurface may include a distribution of chief rays on the surface of the metasurface which may lead to additional considerations in design and camera calibration for depth retrieval. The projector of FIG. 3A including a metasurface may include a higher resolution with less TTL and may be thinner.

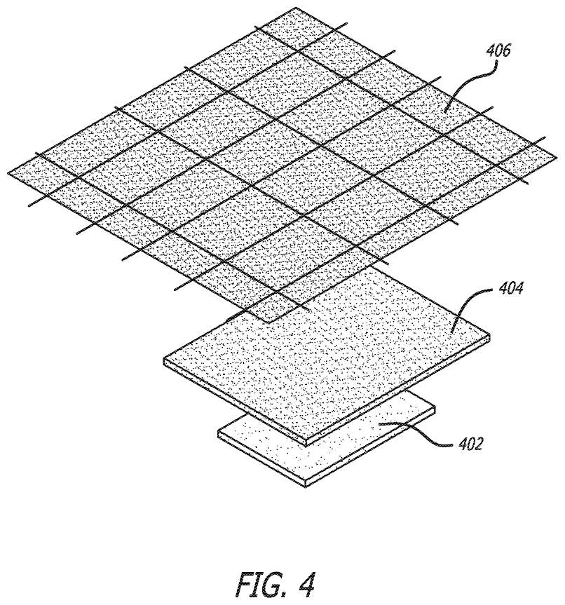

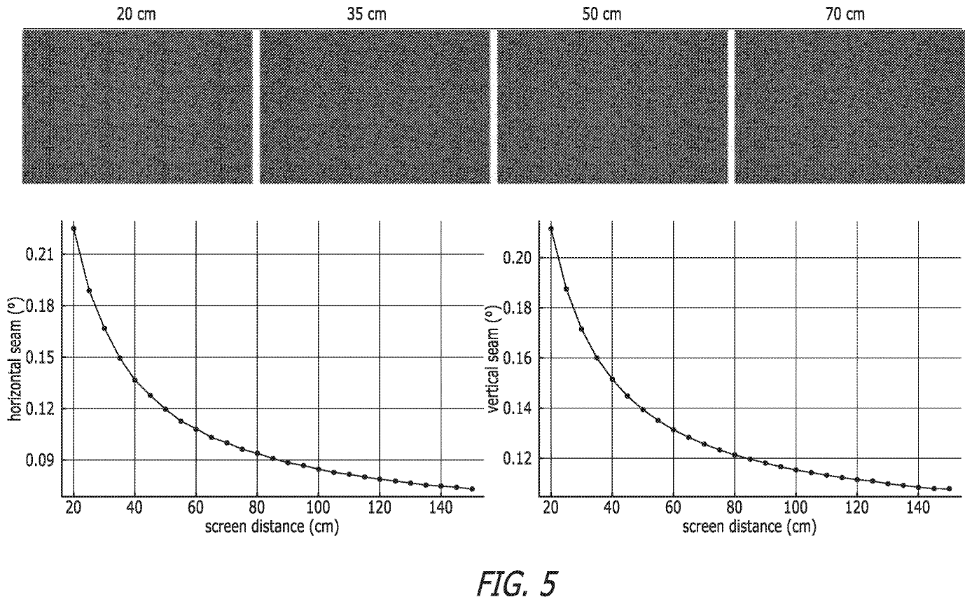

FIG. 4 is an example projector including a metasurface in accordance with an embodiment of the invention. The projector includes a VCSEL array 402 which illuminates a metasurface 404. The metasurface 404 causes the light form the VCSEL array 402 to be an encoded pattern 406 which may be a pseudo-random or regular spot pattern. The metasurface 404 may project and replicate the VCSEL array layout. The metasurface 404 may integrate collimation and fan-out diffraction functionalities into a single surface.

### Examples of Different Distances Between the Object and Depth Sensing System

An invariant angular distribution of energy may have all the chief rays in the projected pattern to emanate from a single point. In case of the projector including a metasurface described in connection with FIG. 3A, the emanating point for the projected chief rays are distributed across the surface of the metasurface. Therefore, In some embodiments, the distance of the metasurface from the object may be sufficient such that the angular energy distribution becomes invariant such that the emanating points of chief rays are effectively viewed as a single point. The wider the distribution of chief rays is (e.g., the larger the dimension of the VCSEL array), the further distance to move away from the metasurface to achieve an invariant angular pattern. For examples of low-resolution spot projectors with small VCSELs, this distance may be ~25 cm while for high-resolution spot projectors with larger VCSELs, this distance can reach up to ~70 cm. The distance may be higher in case of exceptionally larger VCSELs used mostly for LiDAR.

Below the onset of invariant angular distribution, the different origins for diffraction of different emitters causes their diffraction angle to vary slightly in the viewpoint of a global coordinate system with its origin placed at the center of the optic. The further an emitter is from the center of meta-optic, the smaller its diffraction angle would be in the global coordinate system at closer distances. Therefore, the tiles of a spot projector would experience a nonlinear shrinkage at closer distances and a nonlinear expansion at further distances. This is while the location of the center of tiles (which emanates from the center of metasurface) is invariant vs projection distance. At the onset of invariant angular distribution, the tiles have reached their maximum size and they do not expand considerably by moving to further distances. The fixed position of tiles' centers and the shrinkage/expansion vs projection distance makes the gap between stitched tiles of a spot projector (referred to as “seam”) dependent on the distance. In particular, at closer distances the seam is wider due to shrinkage of tiles and at further distances the seam becomes narrower due to expansion of tiles. The design of meta-optic spot projector should take into account the dependency of the seam on the distance and co-optimize the projection and diffraction such that the seam in the pattern can be deemed acceptable across the working distance range. For a pseudo-random spot projector, the acceptable condition for the seam is to avoid dead zones without any signal which can create error in interpolation of depth across the scene as well as overlapping spots leading to non-uniform brightness and spot density.

The top images of FIG. 5 are examples of a pattern of a 7×11 spot projector. The projector may be optimized for operation at distances above 30 cm. The distance between the projector and the object are labeled as 20 cm, 35 cm, 50 cm, and 70 cm. As illustrated, the projector at 20 cm distance has definite seams. As the projector is moved away from the object, the seam diminishes. The bottom graphs of FIG. 5 plot the horizontal seam and the vertical seam at various distances between the projector and the object.

The seam shown vs distance is defined as the angular separation between the spots at the edge of the adjacent central tiles. As it can be seen, the seam varies more dramatically at closer distances up to ~70 cm while remaining almost constant at further distances. The seam only negligibly changes by a fraction of spot width at further distances of greater than 70 cm. The central region of the 7×11 spot pattern projector may be optimized for working distance between 30 cm and 120 cm at different distances showing variation of the seam between the tiles.

In some embodiments, the distance between the projector and the object may be greater than 20 cm, greater than 30 cm, or greater than 70 cm. In some embodiments, the distance between the projector and the object may be between 30 cm and 70 cm, or between 30 cm and 50 cm. The distance between the projector and the object may include the distance between the illumination plane of the projector and the reference plane of the object such that the receiver is calibrated to work at a certain distance between the projector and the object.

### Examples Utilizing a Baseline Matrix for Depth Retrieval

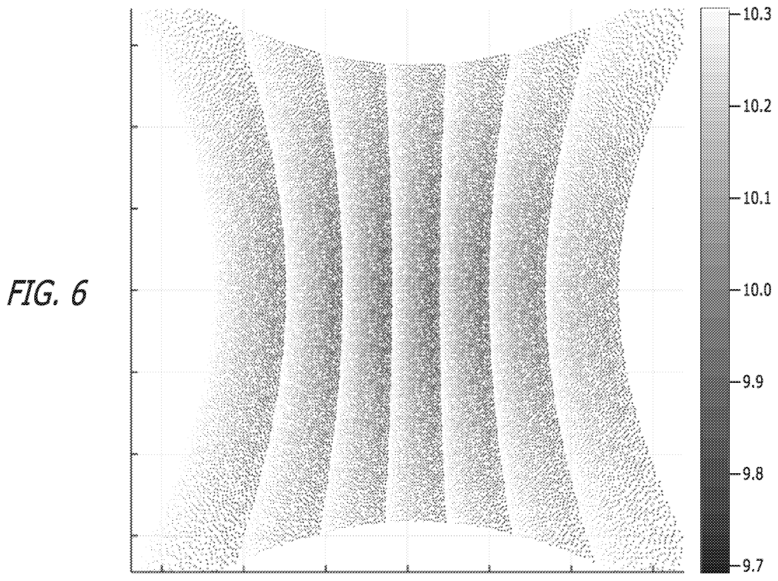

The distribution of emanating points for the spots generated by a metasurface may benefit from a different calibration model to get an accurate depth estimate. As illustrated in FIG. 3A, the baseline used for depth estimation may not be constant for different spots in the reference map since the projected chief rays do not pass through a single point on the diffractive optic. Instead, it may be beneficial to utilize a baseline matrix. The baseline matrix can be obtained by offsetting the constant baseline (defined by the separation between center of Rx pupil and center of Tx) by the location of the projector creating the spot relative to the center of the metasurface as shown schematically in FIG. 3A. FIG. 6 illustrates the baseline corresponding to the different spots which may be used for depth retrieval using the projector including the metasurface as illustrated in FIG. 3A. The baseline is adjusted for each spot in the reference map according to its emitter location. The horizontal baseline of spots in the reference map may be from a 7×11 spot projector, for example, when the center of Rx pupil is set at a distance of 10 mm away from the center of the metasurface. Any number and configuration of spot generation can be used, for example 1×1, 2×2, 5×10 or any other two dimensional set of spots. The vertical baseline matrix can be calculated similarly according to the vertical position of emitters on the VCSEL layout when there is a vertical offset between Rx and Tx. The depth retrieval equation then changes to the following for the basic model:

$${D}_{i} = {D}_{r} - \frac{{D}_{r}}{1 + ( f \cdot ( {b}_{i} ) ) / ( {D}_{r} \cdot {d}_{i} )} \qquad ( 9 )$$

Dᵣ is the depth of reference plane, Dᵢ is the measured depth at the location of the spot matching i-th spot in the reference map, bᵢ is its corresponding baseline, and dᵢ is its corresponding disparity in image space. f is the focal distance of pinhole camera model. The general camera model is provided as follows:

$$[ \begin{matrix}{d}_{i , x} \\ {d}_{i , y} \\ 1\end{matrix} ] = kC [ \begin{matrix}{b}_{i} \frac{{D}_{r} - {D}_{i}}{{D}_{r}} \\ 0 \\ {D}_{i}\end{matrix} ] \qquad ( 10 )$$

kC is the camera matrix of a general camera obtained through calibration. In the above equations a horizontal offset is considered between the Tx and Rx, Dᵢ is the depth at the location of the spot matching the i-th spot in the reference map, dᵢ is its corresponding observed disparity as shown in FIG. 3A, and bᵢ is its corresponding baseline given by:

$${b}_{i} = b + {x}_{i} \qquad ( 11 )$$

with b being the separation between center of Rx pupil and center of Tx, and xᵢ being the position of the emitter corresponding to i-th spot in the reference map in the local coordinate system of Tx.

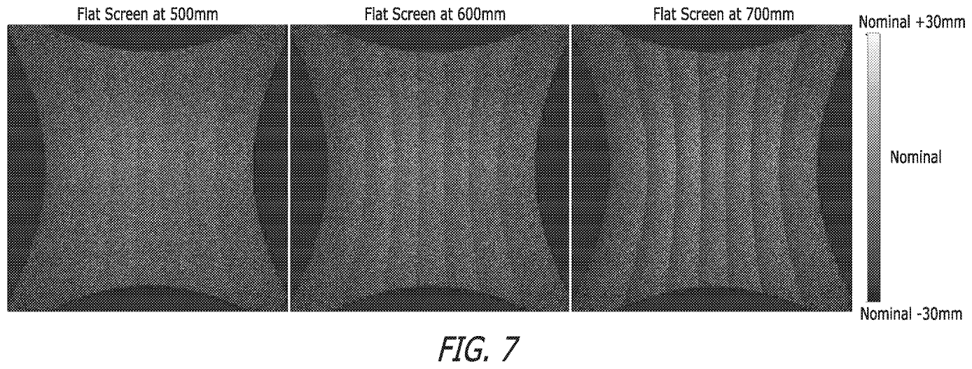

In order to demonstrate the impact of this modification on depth retrieval, a depth sensing system may include the 7×11 spot projector and a horizontal separation of 10 mm between center of Rx pupil and center of Tx. The reference map used for depth retrieval is the spot pattern on a flat screen at a distance of 350 mm. FIG. 7 is various retrieved depth of flat screens at different distances using a calibration map corresponding to a flat screen at 35 cm and using a constant baseline of 10 mm along horizontal direction. In all cases, the color bar is set to a range of +/−30 mm around the nominal depth of the scene. As it can be seen, because of using a constant baseline there is a significant error in the estimated depth which increases by moving further from the distance of reference map. In particular, the depth map shows a horizontal gradient and appearance of vertical dips at further distances. This is because of the horizontal offset of Rx pupil with respect to the center of the metasurface. In the case that there is offset in both directions, the gradient can become two-dimensional and dips can appear along both horizontal and vertical directions.

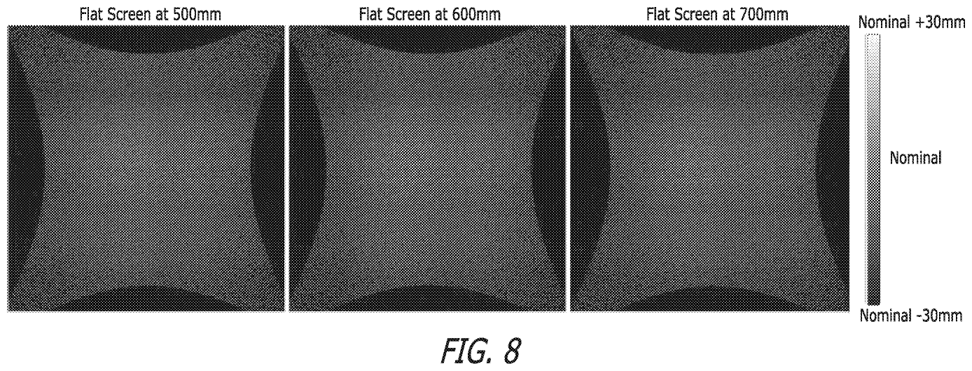

A modified depth retrieval approach employing the baseline matrix shown in FIG. 6 was performed. FIG. 8 is various retrieved depth of flat screens at different distances using a calibration map corresponding to a flat screen at 35 cm and using the baseline matrix shown in FIG. 6. The results illustrated in FIG. 8 verify that the approach yields accurate depth estimation at different distances with no gradient caused by the variability of the seam in the pattern.

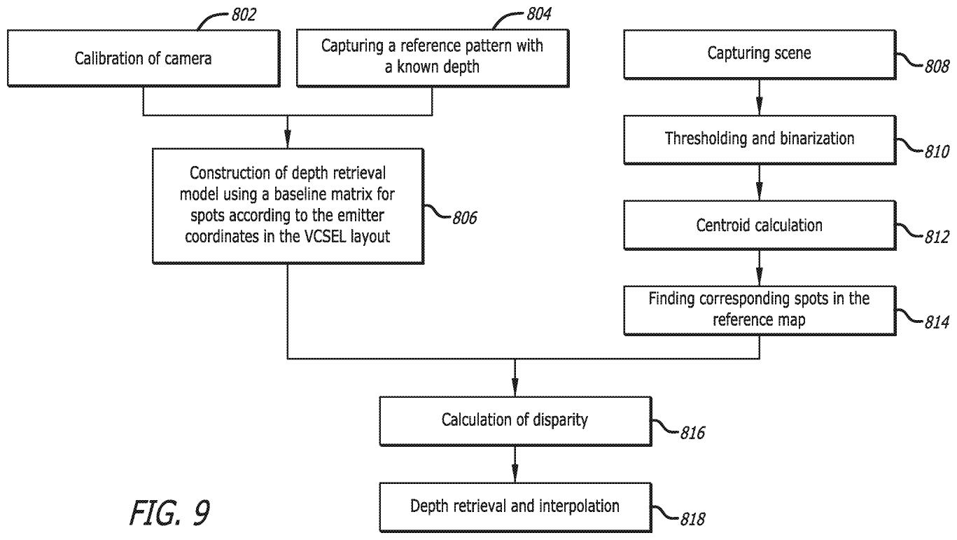

FIG. 9 is a flowchart of depth retrieval with the projector including a metasurface described in connection with FIG. 3A using a model based on a baseline matrix in accordance with an embodiment of the invention.

The process includes calibrating (802) an image sensor to create an image sensor matrix. The construction of the image sensor may be utilized to calibrate the image sensor. The construction of the image sensor may include the focal length of the image sensor and the distance between the pinhole and the center of diffraction of the metasurface as discussed above. The image sensor may be a camera.

The process includes capturing (804) a reference pattern with a known depth. The reference pattern may be a scene with the known depth. The captured reference pattern is used to construct (806) a depth retrieval model. The depth retrieval model including a baseline matrix in which the corresponding baseline to each spot is offset according to its corresponding emitter location.

The process further includes capturing (808) a scene. The scene may include an unknown object with a certain depth profile. The process further includes thresholding and/or binarizing (810) the captured scene. The process further includes calculating (812) the centroid of the captured scene. The centroid may be calculated from the thresholding and/or binarized scene. The process further includes correlating (814) each spot in the captured scene with a corresponding spot in a reference map. The process further includes calculating (816) the disparities in the captured scene using the reference map. The process further includes calculating (818) a depth map from the disparities using the baseline matrix to correct for the different baselines from the offset of the emitter location.

Although, according to Eq. (8) using a reference map at a closer distance leads to better depth resolution, it has been discovered a trade-off of the variability of the seam at close distances for a projector including a metasurface impacting the choice of optimal distance for capturing the reference map. The standard deviation (STD) of depth for retrieved depth of flat screens at different distances based on calibration at different distances and a constant baseline. It should be noted that without using a baseline matrix, the results may be inaccurate, however, this brings out the impact of seam variability on the accuracy of depth retrieval at different distances. A constant horizontal baseline of 10 mm was between Tx and Rx. The results are documented in Table 1:

| | STD of | STD of | STD of | STD of |
|---|---|---|---|---|
| | depth | depth | depth | depth |
| | on Flat | on Flat | on Flat | on Flat |
| Calibration | Screen at | Screen at | Screen at | Screen at |
| Distance | 300 mm | 500 mm | 700 m | 900 m |
| 300 mm | 0.0 mm | 5.93 mm | 16.62 mm | 32.11 mm |
| | (0%) | (1.18%) | (2.37%) | (3.56%) |
| 400 mm | 1.33 mm | 2.23 mm | 9.34 mm | 20.03 mm |
| | (0.44%) | (0.44%) | (1.33%) | (2.22%) |
| 500 mm | 2.13 mm | 0.0 mm | 4.98 mm | 12.82 mm |
| | (0.7%) | (0%) | (0.71%) | (1.42%) |
| 600 mm | 2.66 mm | 1.49 mm | 2.09 mm | 8.02 mm |
| | (0.8%) | (0.29%) | (0.29%) | (0.89%) |
| 700 mm | 3.05 mm | 2.54 mm | 0.0 mm | 4.59 mm |
| | (1%) | (0.5%) | (0%) | (0.51%) |

Table 1 includes standard deviation of estimated depth for a flat screen at different distances using different distances for the reference map. The results here show that the standard deviation of depth becomes less dramatic across the working distance range using calibration at the longer distances (between 50 cm-60 cm) for reference map although it comes at the cost of lower resolution for depth according to Eq. (8).

The above discussed approaches are not exclusive for an optimal distance and projectors including a metasurface. In fact, the same concepts and approaches described above have been discovered to work for a traditional diffractive optical element set at a non-optimal distance.

It has also been discovered that, given the variability of seam across the working distance, for depth retrieval using the pattern projected by a metasurface, identification of corresponding spots in the reference map may be critical. An incorrect identification of corresponding spots can lead to an error in retrieved depth while failure to identify a match or identifying multiple matches for a spot can lead to undefined depth values in the depth map. In this case, the search interval may be adjusted according to the position of the spot as the spot toward the edges of each tile are subject to more variability vs distance.

### Examples of Depth Sensing

Various depth sensing were performed using a human head model with different baselines for the system and different distances using the baseline matrix in the algorithm. In all cases, a pinhole camera model is used with a horizontal separation between Rx pupil center and center of Tx optic. However, the pinhole camera model is merely exemplary and other camera models may be used such as a distortion model. The reference map used was the projected spot pattern on a flat screen at 35 cm.

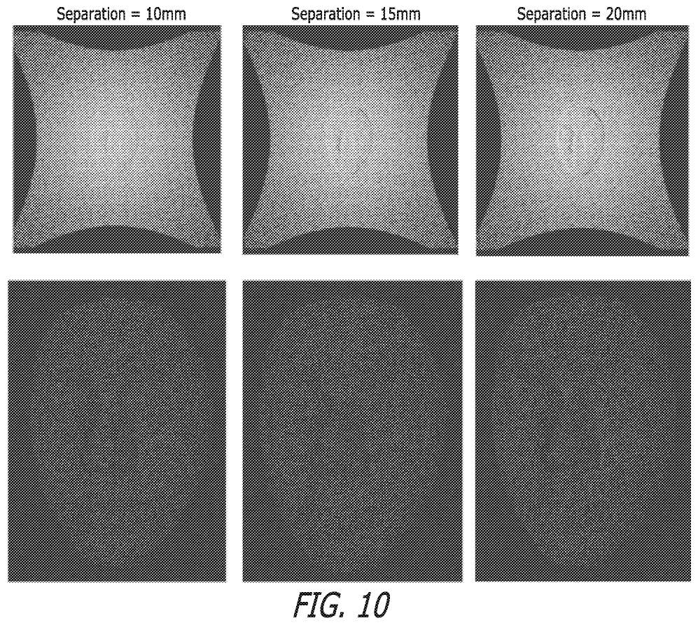

FIG. 10 are various disparity maps and their corresponding retrieved depth maps using a baseline matrix for a human head model placed at a distance of 40 cm and different separations between Rx and Tx along the horizontal direction. The reference map corresponds to projected pattern on a flat screen at 35 cm. The different separations change the baseline such that a larger separate leads to a higher baseline. An increased baseline leads to larger disparity and a better depth resolution at fixed distance consistent with Eq. (8). No gaps or anomalous gradient can be observed in the depth map using the baseline matrix for depth retrieval.

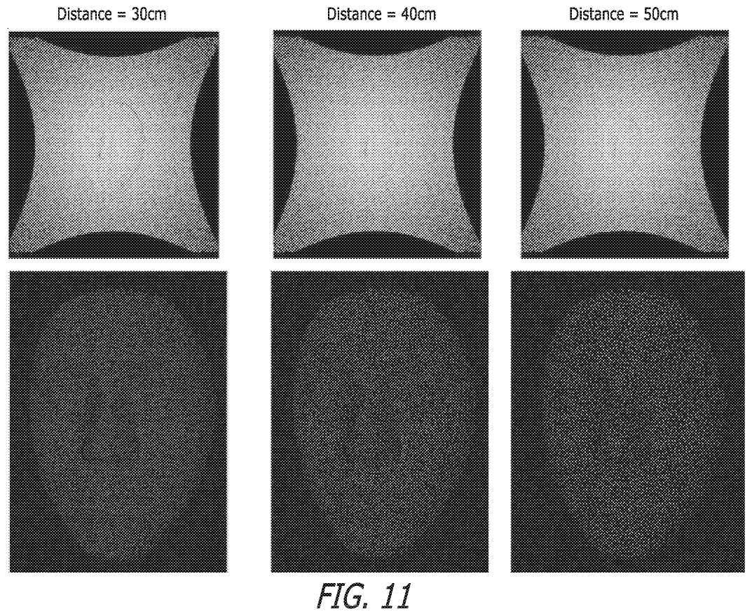

FIG. 11 is various disparity maps and retrieved depths for a human head model placed at different distances for a 10 mm separation between center of Rx pupil and center of Tx. The results show at closer distances a larger disparity and a better depth resolution is achieved consistent with Eq. (8). No gaps or anomalous gradient can be observed in the depth map using the baseline matrix for depth retrieval. The reference map corresponds to projected pattern on a flat screen at 35 cm.

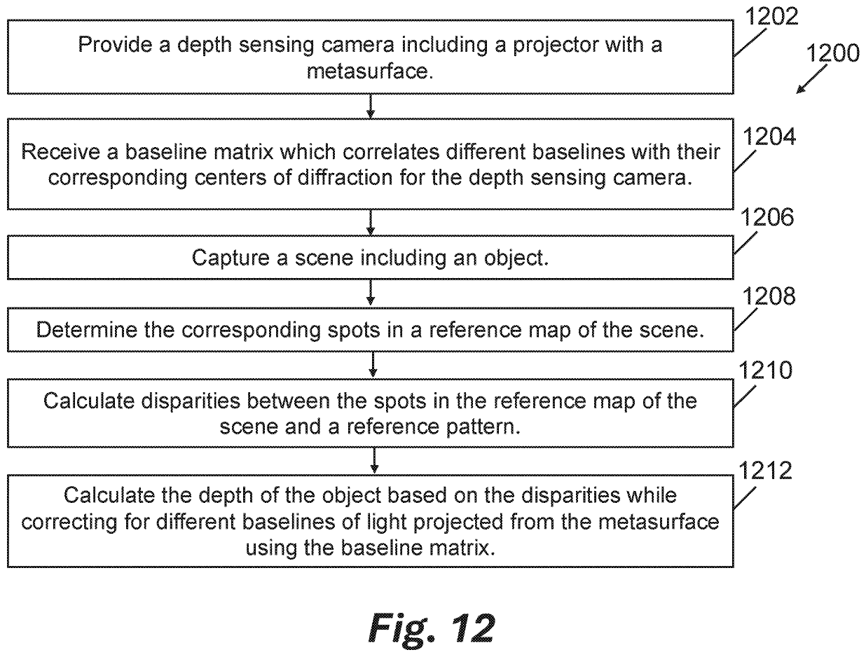

FIG. 12 is a flow chart of a method 1200 of sensing depth in accordance with an embodiment of the invention. The method 1200 includes providing (1202) a depth sensing camera including a projector with a metasurface. The projector includes a light source; and a metasurface. The light source illuminates the metasurface at different transverse locations such that the metasurface projects light in different transverse locations onto an object. The depth sensing camera further includes a receiver including an image sensor configured to receive light that is reflected from off the object. The projector and the receiver are a fixed distance apart such that the light in different transverse locations has a plurality of centers of diffraction which correspond to different baselines which are the distance between the centers of diffraction and a fixed point of the receiver.

The method 1200 further includes receiving (1204) a baseline matrix which correlates the various different baselines with their corresponding centers of diffraction for the depth sensing camera. The method 1200 further includes capturing (1206) a scene including an object. The method 1200 further includes determining (1208) the corresponding spots in a reference map of the scene. The method 1200 further includes calculating (1210) disparities between the spots in the reference map of the scene and a reference pattern. The method 1200 further includes calculating (1212) the depth of the object based on the disparities while correcting for different baselines of light projected from the metasurface using the baseline matrix.

In some embodiments, the method 1200 may further include thresholding the captured scene. Determining the corresponding spots in the reference map of the scene may be based on the thresholded captured scene.

In some embodiments, the method 1200 may further include binarizing the captured scene. Determining the corresponding spots in the reference map of the scene is based on the binarized captured scene.

In some embodiments, the method 1200 may further include calculating the centroid of the threshold captured scene. Determining the corresponding spots in the reference map of the scene may be based on the centroid of the thresholded captured scene.

In some embodiments, the method 1200 may further include calibrating the image sensor to create a camera matrix. The camera matrix may include a camera focus. In some embodiments, the method 1200 may further include capturing a reference pattern with a known depth. The method 1200 may further include constructing a depth retrieval model using the reference pattern with the known depth and the baseline matrix. The depth retrieval model may be expressed by the equation:

$${D}_{i} = {D}_{r} - \frac{{D}_{r}}{1 + ( f \cdot ( {b}_{i} ) ) / ( {D}_{r} \cdot {d}_{i} )} ,$$

where Dᵣ is the depth of the reference pattern at spot matching i-th spot in the reference map, Dᵢ is the measured depth at the location of the i-th spot in the reference map, bᵢ is the baseline at the location of the i-th spot in the reference map, dᵢ is the disparity at the location of the i-th spot in the reference map, and f is the focal distance of the receiver. bᵢ may be provided by:

$${b}_{i} = b + {x}_{i}$$

where b is the separation between a center of a pupil of the receiver and a center of the projector and xᵢ is the position of the emitter corresponding to the i-th spot in the reference map.

In some embodiments, the method 1200 may further include constructing a general camera model which relates the disparities to the depth of the object using the reference pattern with the known depth and the baseline matrix. The general camera model may be represented by the equation:

$$[ \begin{matrix}{d}_{i , x} \\ {d}_{i , y} \\ 1\end{matrix} ] = kC [ \begin{matrix}{b}_{i} \frac{{D}_{r} - {D}_{i}}{{D}_{r}} \\ 0 \\ {D}_{i}\end{matrix} ]$$

where kC is the camera matrix, Dᵣ is the depth of the reference pattern at spot matching i-th spot in the reference map, Dᵢ is the measured depth at the location of the i-th spot in the reference map, bᵢ is the baseline at the location of the i-th spot in the reference map, and dᵢ is the disparity at the location of the i-th spot in the reference map.

The reference pattern may be a reference plane. The metasurface may project a dot pattern onto the object. The light source may be a VCSEL array.

In some embodiments, the receiver includes an aperture and the fixed point of the receiver comprises a point within the aperture. The light reflected off the object passes through the aperture onto the image sensor. The aperture may include a pinhole and the fixed point of the receiver may include a center of the pinhole. In some embodiments, the aperture includes a lens and the fixed point of the receiver comprises a center of the lens.

### DOCTRINE OF EQUIVALENTS

While the above description contains many specific embodiments of the invention, these should not be construed as limitations on the scope of the invention, but rather as an example of one embodiment thereof. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A depth sensing system, comprising:
a projector comprising:
a light source; and
a metasurface, wherein the light source illuminates the metasurface at different transverse locations such that the metasurface projects light onto an object from different directions; and
a receiver comprising an image sensor configured to receive the light reflected from the object,
wherein the projector and the receiver are a fixed distance apart such that the light has a plurality of centers of diffraction on the metasurface which correspond to different baselines which are the distance between the centers of diffraction and a fixed point of the receiver, and wherein the light received by the image sensor corresponds to the depth of the object.

2. The depth sensing system of claim 1, wherein the receiver comprises an aperture and the fixed point of the receiver comprises a point within the aperture, wherein the light reflected off the object passes through the aperture onto the image sensor.

3. The depth sensing system of claim 2, wherein the aperture comprises a pinhole and the fixed point of the receiver comprises a center of the pinhole.

4. The depth sensing system of claim 2, wherein the aperture comprises a lens and the fixed point of the receiver comprises a center of the lens.

5. The depth sensing system of claim 1, wherein a separation between the projector and the receiver is between 10 mm to 20 mm.

6. The depth sensing system of claim 1, wherein a distance between the projector and the object is greater than 30 cm.

7. The depth sensing system of claim 1, wherein a distance between the projector and the object is between 30 cm and 120 cm.

8. The depth sensing system of claim 1, wherein the metasurface is configured to collimate and fan-out the light from the light source.

9. The depth sensing system of claim 1, wherein the metasurface projects light in different transverse locations onto the object.

10. The depth sensing system of claim 1, wherein the projected light from the metasurface comprises a dot pattern.

11. The depth sensing system of claim 1, wherein the projected light from the metasurface comprises pseudo-random or regular light.

12. The depth sensing system of claim 1, wherein the image sensor if configured to be calibrated to create a camera matrix.

13. The depth sensing system of claim 12, wherein the camera matrix comprises a camera focus.

14. The depth sensing system of claim 1, wherein the light source is one of: a VCSEL array a light emitting diode (LED), or an array of LEDs.

15. The depth sensing system of claim 14, wherein the VCSEL array comprises three different VCSEL light sources that are configured to output light at different positions.

16. The depth sensing system of claim 14, wherein the metasurface is configured to project and replicate the VCSEL array layout.

17. The depth sensing system of claim 1, wherein the metasurface integrates collimation and fan-out into a single surface.
